(19) United States
(12) Patent Application Publication
(10) Pub. No.: US 2017/0186234 A1
(43) Pub. Date: Jun. 29, 2017

(54) METHOD AND DEVICE FOR FREE VIEWING OF THREE-DIMENSIONAL VIDEO

(71) Applicants: Le Holdings (Beijing) Co., Ltd., Chao Yang District (CN); Le Shi Zhi Xin Electronic Technology (Tianjin) Limited, Binhai New Area (CN)

(72) Inventor: Xiaofei Xu, Binhai New Area (CN)

(21) Appl. No.: 15/239,969

(22) Filed: Aug. 18, 2016

Related U.S. Application Data
(63) Continuation of application No. PCT/CN2016/089571, filed on Jul. 10, 2016.

(30) Foreign Application Priority Data
Dec. 27, 2015 (CN) 201511002914.2

(51) Int. Cl. G06T 19/00; G06T 15/20; G06T 7/60; H04N 13/04; G06T 7/00

(52) U.S. Cl. CPC G06T 19/006; H04N 13/0452; G06T 7/004; G06T 7/60; G06T 15/20

(57) ABSTRACT

The embodiments of the present disclosure relate to the technical field of virtual reality, and disclose a free viewing method for a three-dimensional video and an electronic device. In some embodiments of the present disclosure, respective rotation matrices of a current viewpoint in three dimensional directions are calculated; a current viewing orientation is calculated according to the rotation matrices in the three dimensional directions and an original viewing orientation; an orientation matrix of a viewer is calculated according to the current viewing orientation; a three-dimensional video is played by using an inverse matrix of the calculated orientation matrix as a position of a three-dimensional video in the coordinate system of the viewer. Adopting the embodiments of the present disclosure enables the display of a three-dimensional video to automatically adapt to a current viewpoint position of a user along with free change of the position of the user.

### CROSS-REFERENCE TO RELATED APPLICATIONS

The present disclosure claims priority to Chinese Patent Application No. 201511002914.2, filed with the Chinese Patent Office on Dec. 27, 2015, which is incorporated herein by reference in its entirety.

### TECHNICAL FIELD

The present application relates to the technical field of virtual reality, and in particular, to a free viewing method and device for a three-dimensional video.

### BACKGROUND

The inventor discovered in the process of achieving the present application that with the development of science and technology, the application of the virtual reality (VR, for short) technology in the field of video display gradually becomes mature. At present, there have been a great amount of viewing solutions based on intelligent terminals, such as mobile phones, so that users can enjoy the playing effect of the conventional 3D cinema without leaving home. However, in current mobile phone-based virtual reality (VR) solutions, the viewing mode of users is still limited to fixed scenes, that is, viewers can only simply change the angle of view in the horizontal direction, users cannot adopt the lying position or side-lying position to continue to watch when needing to rest, and as a result, the flexibility of the viewing mode provided for users is very inadequate.

### SUMMARY

An objective of some embodiments of the present disclosure is to provide a free viewing method and device for a three-dimensional video, so that the display of the three-dimensional video can automatically adapt to a viewpoint position of a user along with free change of the position of the user. Therefore, free viewing can be realized, and the user experience can be improved.

In order to solve the technical problem, an implementation manner of the present disclosure provides a free viewing method for a three-dimensional video, which includes the following steps: calculating rotation matrices of a current viewpoint respectively in three dimensional directions; calculating a current viewing orientation according to the rotation matrices in the three dimensional directions and an original viewing orientation; calculating an orientation matrix of a viewer according to the current viewing orientation; and playing the three-dimensional video by using an inverse matrix of the calculated orientation matrix as a position of the three-dimensional video in the coordinate system of the viewer.

One embodiment of the present disclosure provides a computer-readable storage medium, which includes computer-executable instructions, and when the computer-executable instructions are executed by at least one processor, the processor executes the method.

The implementation manner of the present disclosure also provides a free viewing device for a three-dimensional video, which includes: a rotation matrix calculation module, configured to calculate respective rotation matrices of a current viewpoint in three dimensional directions; a viewing orientation calculation module, configured to calculate a current viewing orientation according to the rotation matrices in the three dimensional directions and an original viewing orientation; an orientation matrix calculation module, configured to calculate an orientation matrix of a viewer according to the current viewing orientation; and a playing module for playing the three-dimensional video by using an inverse matrix of the calculated orientation matrix as a position of the three-dimensional video in the coordinate system of the viewer.

As compared with the prior art, in this implementation manner, by calculating respective rotation matrices of a current viewpoint in three dimensional directions, then calculating a current viewing orientation according to the rotation matrices in the three dimensional directions and an original viewing orientation, and calculating an orientation matrix of a viewer according to the current viewing orientation, a three-dimensional video can be played by using an inverse matrix of the calculated orientation matrix as a position of the three-dimensional video in the coordinate system of the viewer. Thus, this implementation manner can adjust a screen of a three-dimensional video to adapt to a current viewpoint position of a viewer based on free change of the position of the viewer in a three-dimensional space, so that the viewer can freely view a three-dimensional video, such as virtual reality.

### BRIEF DESCRIPTION OF THE DRAWINGS

FIG. 1 is a flow chart of a free viewing method for a three-dimensional video according to a first implementation manner of the present disclosure; and

FIG. 2 is a structure diagram of a free viewing device for a three-dimensional video according to a second implementation manner of the present disclosure.

### DETAILED DESCRIPTION

To make the objective, technical solutions, and advantages of the present disclosure clearer, the following further describes the present disclosure in detail with reference to the specific implementation manners and the accompanying drawings. A person of ordinary skill in the art may understand that technical details are described in embodiments of the present disclosure to make readers more easily understand the present disclosure. However, if the technical details and various changes and modifications on the basis of the following implementation manners are not described, the technical solution needing protection in the present disclosure may be implemented.

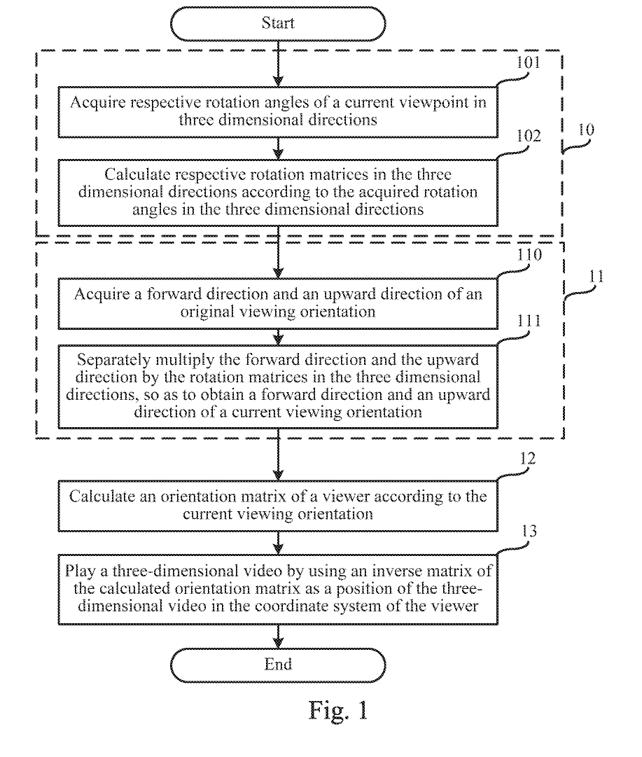

The first implementation manner of the present disclosure relates to a free viewing method for a three-dimensional video, the specific flow is as shown FIG. 1, and the method includes the following Step 10 to Step 13:

Step 10: Calculate respective rotation matrices of a current viewpoint in three dimensional directions, so that the current viewpoint can be rotated on the basis of a view matrix of a three-dimensional scene. The specific calculation step includes the following substep 101 and substep 102.

Substep 101: Acquire respective rotation angles of the current viewpoint in the three dimensional directions.

When the angle of view of a viewer changes, for example, the viewing direction deviates when the viewer is adjusted from a forward sitting posture to a reclining posture, a viewpoint position in a three-dimensional view of the embodiment can be adjusted according to the deviation angle of the user. For example, the user wears a terminal device to view a three-dimensional video, a sensor is installed in the terminal device, and the sensor can track the rotation of the head of the viewer. Therefore, the sensor installed in the terminal device (i.e., a 3D viewing device) can be utilized to detect current deviation angles of the terminal device relative to an original position in x-axis, y-axis and z-axis directions, and the three deviation angles detected by the sensor are used as respective rotation angles of the current viewpoint in the three dimensional directions.

Substep 102: Calculate respective rotation matrices in the three dimensional directions according to the acquired rotation angles in the three dimensional directions.

The rotation matrix means rotation angles of an object in a three-dimensional space which are represented in the form of a matrix. If the rotation angle value of the viewpoint is set as θ, the matrices of the rotation of the object respectively around rotation axes X, Y and Z in a three-dimensional scene are represented as follows:

Matrix obtained by rotation around the rotation axis Z:

$$\vert \begin{matrix}cos θ & sin θ & 0 & 0 \\ - sin θ & cos θ & 0 & 0 \\ 0 & 0 & 1 & 0 \\ 0 & 0 & 0 & 1\end{matrix} \vert$$

Matrix obtained by rotation around the rotation axis X:

$$\vert \begin{matrix}1 & 0 & 0 & 0 \\ 0 & cos θ & sin θ & 0 \\ 0 & - sin θ & cos θ & 0 \\ 0 & 0 & 0 & 1\end{matrix} \vert$$

Matrix obtained by rotation around the rotation axis Y:

$$\vert \begin{matrix}cos θ & 0 & - sin θ & 0 \\ 0 & 1 & 0 & 0 \\ sin θ & 0 & cos θ & 0 \\ 0 & 0 & 0 & 1\end{matrix} \vert$$

On the basis of the rotation matrices obtained from the rotation of the object around X, Y and Z, a rotation matrix of rotation around any vector can be obtained according to the rotation matrices. If M is set as a matrix after the rotation of a unit matrix around a vector a, a=(xₐ, yₐ, zₐ) and the rotation angle is a,

$$M = \vert \begin{matrix}( 1 - cos α ) {x}_{a}^{2} + cos α & ( 1 - cos α ) {x}_{a} {y}_{a} + sin α {z}_{a} & ( 1 - cos α ) {x}_{a} {z}_{a} - sin α {y}_{a} & 0 \\ ( 1 - cos α ) {x}_{a} {y}_{a} - sin α {z}_{a} & ( 1 - cos α ) {y}_{a}^{2} + cos α & ( 1 - cos α ) {y}_{a} {z}_{a} + sin α {x}_{a} & 0 \\ ( 1 - cos α ) {x}_{a} {z}_{a} + sin α {y}_{a} & ( 1 - cos α ) {y}_{a} {z}_{a} - sin α {x}_{a} & ( 1 - cos α ) {z}_{a}^{2} + cos α & 0 \\ 0 & 0 & 0 & 1\end{matrix} \vert$$

Step 11: Calculate a current viewing orientation according to the rotation matrices in the three dimensional directions and an original viewing orientation. That is, the angle of view of a view matrix of a three-dimensional scene is adjusted according to the change of the angle of view of the user, to correspond to the viewing direction of the user.

Step 11 specifically includes the following substep 110 to substep 111.

Substep 110: Acquire a forward direction and an upward direction of the original viewing orientation. The original viewing orientation is an initial viewing orientation in the three-dimensional view matrix or a viewing orientation corresponding to the previous angle of view of the user. The viewing orientation includes two vectors in the forward direction and the upward direction.

Substep 111: Separately multiply the forward direction and the upward direction by the rotation matrices in the three dimensional directions, so as to obtain a forward direction and an upward direction of a current viewing orientation. Thereby, the rotation of the three-dimensional view matrix according to the angle of view of the user is implemented.

Step 12: Calculate an orientation matrix of the viewer according to the current viewing orientation.

A calculation method for the orientation matrix is illustrated below:

set angle values of the rotation of the angle of a viewpoint around the x axis, the y axis and the z axis respectively as: EyeYaw, EyePitch and EyeRoll, and obtain a total rotation matrix rollPitchYaw:

Matrix4f rollPitchYaw=Matrix4f::RotationY(EyeYaw)

* Matrix4f::RotationX(EyePitch)

* Matrix4f::RotationZ(EyeRoll);

set an upward vector in an initial state as Up, a forward vector as Forward, and a viewpoint position as eye; obtain through calculation values after the rotation of the vectors as follows:

constVector3f up=rollPitchYaw·Transform(Up);

constVector3f forward=rollPitchYaw·Transform(Forward);

constVector3feye=(0,0,0);

according to the up, forward and eye, obtain, through calculation, a final orientation matrix m:

Vector3z=(eye−forward)·Normalized( )

Vector3x=up·Cross(z)·Normalized( )

Vector3v=z·Cross(x);

Matrix4 m(x·x·x·y·x·i·−(x·Dot(eye)).

y·x, y·y·y·z·−(y·Dot(eye)).

z·x·z·y·z·z·−(z·Dol(eye)).

0, 0, 0, 1);

the Normalized, Cross and Dot are normalization, cross product and dot product.

Step 13: Play the three-dimensional video by using an inverse matrix of the calculated orientation matrix as a position of the three-dimensional video in the coordinate system of the viewer.

Implementation of this implementation manner is illustrated below:

1. According to a view matrix View Matrix of a three-dimensional scene, calculate to obtain angles vector3 angle (angle_x, angle_y and angle_z) of a viewpoint in x, y and z directions;

2. According to the values of the angles, calculate to obtain rotation matrices matrix_x, matrix_y and matrix_z of the angle_x, the angle_y and the angle_z;

3. Set an initial viewing forward direction as Forward Vector(0,0,−1), i.e., the negative direction of the Z axis, and an initial upward direction as Up Vector(0,1,0); multiply the two vectors are by the matrix_x, the matrix_y and the matrix_z obtained in the previous step, so as to obtain, through calculation, a forward orientation New_Forward Vector and an upward orientation New_Up Vector of the viewer after rotation;

4. Assume that the viewpoint of the viewer is at the origin position (0,0,0); calculate to obtain an orientation matrix result Matrix of the viewer according to the New_Forward Vector and the New_Up Vector obtained in the previous step; and

5. Calculate to obtain an inverse matrix result Matrix.Inverse( ) of the orientation matrix, where the matrix is the position of a screen in the coordinate system of viewing.

As compared with the prior art, in this implementation manner, by carrying out rotation transformation on a three-dimensional view matrix by means of the tracked current angle of view of a user, so that the transformed three-dimensional view matrix can be played according to the position of the current angle of view of the user, the limitation of present virtual reality viewing solutions based on mobile phones and the like on the angle of view of users is broken through, users can flexibly adjust the viewing mode, and the user experience is improved.

The above methods are divided into steps for clear description. When the methods are achieved, the steps may be combined into one step or some steps may be divided into more steps, which shall fall within the protection scope of the present disclosure only if the steps include a same logic relation; the algorithm and flow to which inessential modification is made or inessential design is introduced without changing the core design of the algorithm and flow shall fall within the protection scope of the present disclosure.

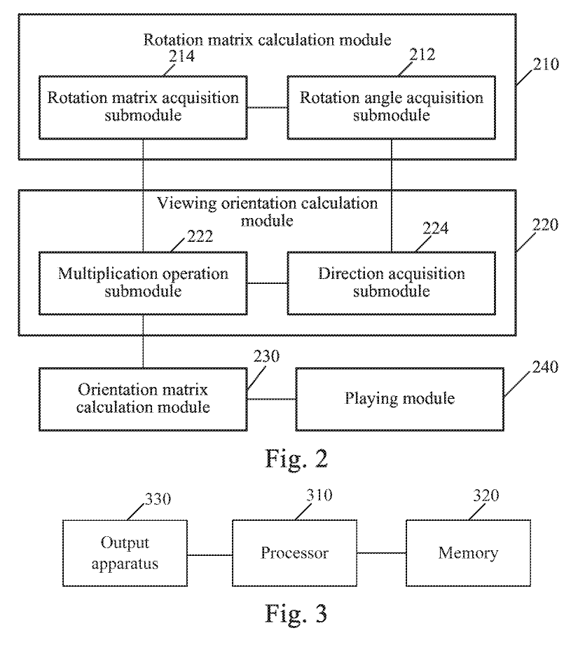

A second implementation manner of the present disclosure relates to a free viewing device. As shown in FIG. 2, the free viewing device includes: a rotation matrix calculation module, a viewing orientation calculation module, an orientation matrix calculation module, and a playing module.

Specifically, the rotation matrix calculation module includes: a rotation angle acquisition submodule and a rotation matrix acquisition submodule. The rotation angle acquisition submodule is configured to acquire respective rotation angles of a current viewpoint in three dimensional directions. As an example but not as restriction, the rotation angle acquisition submodule in this implementation manner can be a sensor which is installed in a terminal device worn by a user. The sensor is configured to track an angle of view of a user. A gyroscope can be used as the sensor. The sensor is utilized to detect current deviation angles of the terminal device relative to an original position in x-axis, y-axis and z-axis directions, and the three deviation angles detected by the sensor are used as respective rotation angles of the current viewpoint in the three dimensional directions. The rotation matrix acquisition submodule is configured to calculate respective rotation matrices in the three dimensional directions according to the acquired rotation angles in the three dimensional directions.

The viewing orientation calculation module includes: a direction acquisition submodule and a multiplication operation submodule. The direction acquisition submodule is configured to acquire a forward direction and an upward direction of an original viewing orientation, and the multiplication operation submodule is configured to separately multiply the forward direction and the upward direction by the rotation matrices in the three dimensional directions to obtain a forward direction and an upward direction of a current viewing orientation.

The orientation matrix calculation module is configured to calculate an orientation matrix of the viewer according to the current viewing orientation, i.e. the forward direction and upward direction of the current viewing orientation.

The playing module is configured to play a three-dimensional video by using an inverse matrix of the calculated orientation matrix as a position of the three-dimensional video in the coordinate system of the viewer.

The present embodiment is characterized by utilizing deviation angles based on the angle of view of a user to adjust the angle of display of a three-dimensional view matrix, so that a three-dimensional video can be played following the angle of view of the user. Therefore, the limitation of the viewing mode of users is broken through, and the flexibility of the viewing mode of users is increased.

It is not difficult to find that this implementation manner is an embodiment of an apparatus corresponding to the first implementation manner, and this implementation manner may be implemented in combination with the first implementation manner. Related technical details described in the first implementation manner are still effective in this implementation manner. To reduce duplication, the technical details are not described herein again. Correspondingly, related technical details described in this implementation manner may also be applied to the first implementation manner.

It should be noted that modules involved in this implementation manner are logic modules. In practical application, a logical unit may be a physical unit, a part of a physical unit, or a combination of multiple physical units. In addition, to highlight innovation part of the present disclosure, a unit that is not closely related to the technical problem put forward in the present disclosure is not introduced, which do not indicate that there is no another unit in this implementation manner.

Steps of the methods or algorithms that are described with reference to the embodiments revealed in the present disclosure may be directly embodied in hardware, a software module executed by a processor or a combination of the both. The software module may be resident in a random access memory (RAM), a flash memory, a read only memory (ROM), a programmable read only memory (PROM), an erasable read only memory (EROM), an erasable programmable read only memory (EPROM), an electrically erasable programmable read-only memory (EEPROM), a register, a hard disk, a removable disk, a compact disc read-only memory (CD-ROM) or any one form of storage medium that is known in the art. In an alternative solution, the storage medium may be integrated with the processor. The processor and the storage medium may be resident in an application-specific integrated circuit (ASIC). The ASIC may be resident in a computing apparatus or a user terminal, or, the processor and the storage medium may be resident in the computing apparatus or the user terminal as discrete components.

A person of ordinary skill in the art may understand that the foregoing implementation manners are specific embodiments of the present disclosure, but in the practical application, various changes in the form and details may be made without departing from the spirit and scope of the present disclosure.

1. A free viewing method for a three-dimensional video, applied to an electronic device, comprising the following steps:
calculating respective rotation matrices of a current viewpoint in three dimensional directions;
calculating a current viewing orientation according to the rotation matrices in the three dimensional directions and an original viewing orientation;
calculating an orientation matrix of a viewer according to the current viewing orientation; and
playing the three-dimensional video by using an inverse matrix of the calculated orientation matrix as a position of the three-dimensional video in the coordinate system of the viewer.

2. The free viewing method for a three-dimensional video according to claim 1, wherein the step of calculating the rotation matrices of the current viewpoint respectively in the three dimensional directions comprises the following substeps:
acquiring respective rotation angles of the current viewpoint in the three dimensional directions; and
calculating respective rotation matrices in the three dimensional directions according to the acquired rotation angles in the three dimensional directions.

3. The free viewing method for a three-dimensional video according to claim 2, wherein in the step of acquiring the respective rotation angles of the current viewpoint in the three dimensional directions, a sensor installed in a terminal device is utilized to detect current deviation angles of the terminal device relative to an original position in x-axis, y-axis and z-axis directions, and the three deviation angles detected by the sensor are used as respective rotation angles of the current viewpoint in the three dimensional directions,
wherein the terminal device is a device for viewing the three-dimensional video and rotating along with the viewer.

4. The free viewing method for a three-dimensional video according to claim 1, wherein the step of calculating the current viewing orientation according to the rotation matrices in the three dimensional directions and the original viewing orientation comprises the following substeps:
acquiring a forward direction and an upward direction of the original viewing orientation; and
separately multiplying the forward direction and the upward direction by the rotation matrices in the three dimensional directions, so as to obtain a forward direction and an upward direction of the current viewing orientation.

5-9. (canceled)

10. A non-volatile computer storage medium, which stores computer executable instructions, that when executed by an electronic device, cause the electronic device to:
calculate respective rotation matrices of a current viewpoint in three dimensional directions;
calculate a current viewing orientation according to the rotation matrices in the three dimensional directions and an original viewing orientation;
calculate an orientation matrix of a viewer according to the current viewing orientation; and
play the three-dimensional video by using an inverse matrix of the calculated orientation matrix as a position of the three-dimensional video in the coordinate system of the viewer.

11. The non-volatile computer storage medium according to claim 10, wherein the instructions to calculate the rotation matrices of the current viewpoint respectively in the three dimensional directions cause the electronic device to:
acquire respective rotation angles of the current viewpoint in the three dimensional directions; and
calculate respective rotation matrices in the three dimensional directions according to the acquired rotation angles in the three dimensional directions.

12. The non-volatile computer storage medium according to claim 11, wherein in the step of acquiring the respective rotation angles of the current viewpoint in the three dimensional directions, a sensor installed in a terminal device is utilized to detect current deviation angles of the terminal device relative to an original position in x-axis, y-axis and z-axis directions, and the three deviation angles detected by the sensor are used as respective rotation angles of the current viewpoint in the three dimensional directions,
wherein the terminal device is a device for viewing the three-dimensional video and rotating along with the viewer.

13. The non-volatile computer storage medium according to claim 10, wherein the instructions to calculate the current viewing orientation according to the rotation matrices in the three dimensional directions and the original viewing orientation cause the electronic device to:
acquire a forward direction and an upward direction of the original viewing orientation; and
separately multiply the forward direction and the upward direction by the rotation matrices in the three dimensional directions, so as to obtain a forward direction and an upward direction of the current viewing orientation.

14. An electronic device, comprising:
at least one processor; and
a memory communicably connected with the at least one processor for storing instructions executable by the at least one processor,
wherein execution of the instructions by the at least one processor causes the at least one processor to:
calculate respective rotation matrices of a current viewpoint in three dimensional directions;
calculate a current viewing orientation according to the rotation matrices in the three dimensional directions and an original viewing orientation;
calculate an orientation matrix of a viewer according to the current viewing orientation; and
play the three-dimensional video by using an inverse matrix of the calculated orientation matrix as a position of the three-dimensional video in the coordinate system of the viewer.

15. The electronic device according to claim 14, wherein the execution of the instructions to calculate the rotation matrices of the current viewpoint respectively in the three dimensional directions cause the at least one processor to:
acquire respective rotation angles of the current viewpoint in the three dimensional directions; and
calculate respective rotation matrices in the three dimensional directions according to the acquired rotation angles in the three dimensional directions.

16. The electronic device according to claim 15, wherein in the step of acquiring the respective rotation angles of the current viewpoint in the three dimensional directions, a sensor installed in a terminal device is utilized to detect current deviation angles of the terminal device relative to an original position in x-axis, y-axis and z-axis directions, and the three deviation angles detected by the sensor are used as respective rotation angles of the current viewpoint in the three dimensional directions,
wherein the terminal device is a device for viewing the three-dimensional video and rotating along with the viewer.

17. The electronic device according to claim 15, wherein the execution of the instructions to calculate the current viewing orientation according to the rotation matrices in the three dimensional directions and the original viewing orientation cause the at least one processor to:
acquire a forward direction and an upward direction of the original viewing orientation; and
separately multiply the forward direction and the upward direction by the rotation matrices in the three dimensional directions, so as to obtain a forward direction and an upward direction of the current viewing orientation.
